(19) United States
(12) Patent Application Publication
(10) Pub. No.: US 2005/0255027 A1
(43) Pub. Date: Nov. 17, 2005

(54) Method for producing alkaline earth metal carbonate crystal and alkaline earth metal carbonate crystal

(75) Inventors: Hiroyuki Hirai, Minami-ashigara-shi (JP); Keiko Sugihara, Minami-ashigara-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-ashigara-shi (JP)

(21) Appl. No.: 11/107,925

(22) Filed: Apr. 18, 2005

(30) Foreign Application Priority Data
Apr. 20, 2004 (JP) 2004-123657

(51) Int. Cl. C01F 11/18

(52) U.S. Cl. 423/430

(57) ABSTRACT

A method for producing an alkaline earth metal carbonate crystal comprising allowing an alkaline earth metal ion that is present at an ion concentration of 0.5 mol/L or less and a carbonate ion to react under an alkali condition to generate an alkaline earth metal carbonate crystal having an aspect ratio of 1.5 or more. An alkaline earth metal carbonate crystal produced by the method is preferably blended with an optical resin and can sufficiently reduce the birefringence and prevent deterioration of the original optical resin.

### BACKGROUND OF THE INVENTION

1. Field of the Invention

The present invention relates to a method for producing a needle or bar crystal of alkaline earth metal carbonate and crystal of alkaline earth metal carbonate, in more detail, a method for producing a crystal of alkaline earth metal carbonate that, when it is applied to an optical film that is formed into a film according to a stretching method or an injection molding method, can diminish the optical anisotropy of the optical film and the crystal of alkaline earth metal carbonate.

2. Description of Related Art

Inorganic glass, having excellent optical characteristics such that it is excellent in the transparency and less in the optical anisotropy, is widely used as an optical material of optical products. However, there are problems in that it is heavy, liable to be broken and poor in the productivity; accordingly, recently, optical resins that can replace the inorganic glass have been actively studied. The optical resin is lighter, less expensive and more excellent in the machinability and mass productivity than the inorganic glass. In particular, the optical resin has a great advantage in that a molding technology of polymer materials such as an injection molding or an extrusion molding can be readily applied.

However, an optical film that is obtained by applying an existing molding technology has the nature of exhibiting not small birefringence. The birefringence becomes a factor that deteriorates the optical characteristics of the optical film. For instance, as is well known in a liquid crystal device, a liquid crystal layer disposed between a polarizer and an analyzer in crossed nicols or parallel nicols rotates a polarization plane of polarized light, and thereby the transmission/non-transmission of light is controlled. Accordingly, in the liquid crystal device, the birefringence (in particular, orientation birefringence) of the respective members that constitute it becomes very important, and this largely inhibits the optical resin from being widely applied to the liquid crystal devices.

As to an improvement in the birefringence in the optical resin, various kinds of proposals have been submitted. For instance, a method in which substantially 1% by mass of water-insoluble inorganic powder is added in an optical resin to reduce the birefringence of an optical resinous product is known (WO 03/076982 A1, WO 01/25364 A1, and Tagaya et al., Compensation of the Birefringence of a Polymer by a Birefringent Crystal, SCIENCE, Vol. 301, 8 Aug., 2003, p812 to 814). A resinous product obtained by use of the method is reduced in the birefringence to some extent compared with a resinous product that does not use the method. However, the reduction of the birefringence is not enough to allow applying to a liquid crystal device.

Furthermore, as another device of reducing the birefringence, a method in which two kinds of polymers of which signs of the orientation birefringence are opposite to each other and that are completely compatible each other are blended to cancel out the birefringence to reduce the birefringence is known (U.S. Pat. No. 4,373,065). However, when different polymers are blended as in this method, the nature of the optical resin is altered; accordingly, there is a disadvantage in that advantages of the optical polymers before blending are diminished.

The object of the present invention is to provide a method for producing an alkaline earth metal carbonate crystal that can sufficiently reduce the birefringence when it is applied to an optical resin and does not deteriorate the nature of an original optical resin; and an alkaline earth metal carbonate crystal.

The present inventors, in order to overcome the foregoing problems, studied hard a method of growing an alkaline earth metal carbonate crystal and found that, when an alkaline earth metal and a carbonate ion are allowed to react under predetermined conditions, a needle or bar alkaline earth metal carbonate crystal high in the aspect ratio can be obtained. Thereby, the present invention came to completion.

### SUMMARY OF THE INVENTION

That is, an object of the present invention can be achieved by a method for producing an alkaline earth metal carbonate crystal and the alkaline earth metal carbonate below.

(1) A first aspect of the invention is a method for producing an alkaline earth metal carbonate crystal that includes reacting an alkaline earth metal ion that is present at an ion concentration of 0.5 mol/L or less and a carbonate ion under an alkali condition to generate an alkaline earth metal carbonate crystal having an aspect ratio of 1.5 or more.

(2) It is preferable that, in the foregoing (1), as a material that supplies the alkaline earth metal ion, hydroxide or acetate of an alkaline earth metal is used, and, as a material that supplies the carbonate ion, at least one kind selected from the group consisting of ammonium carbonate, ammonium hydrogen carbonate and carbon dioxide gas is used.

(3) It is preferable that, in the foregoing (1) or (2), the reaction is carried out in the presence of an aminoalcohol.

(4) It is preferable that, in any one of the foregoing (1) through (3), the reaction between the alkaline earth metal ion and the carbonate ion is carried out in the presence of gelatin.

(5) It is preferable that the foregoing (4) further includes decomposing the gelatin.

(6) It is preferable that any one of the foregoing (1) through (5) further includes drying generated alkaline earth metal carbonate crystal.

(7) It is preferable that, in the foregoing (6), the generated alkaline earth metal carbonate crystal is dried by means of freeze drying or spray drying.

(8) It is preferable that any one of the foregoing (1) through (7) further includes sintering the generated alkaline earth metal carbonate crystal.

(9) It is preferable that any one of the foregoing (1) through (8) further includes covering a surface of the generated alkaline earth metal crystal with a compound insoluble in water.

(10) It is preferable that, in the foregoing (9), as the compound insoluble in water, a silane coupling agent or a titanium coupling agent is used.

(11) A second aspect of the invention is an alkaline earth metal crystal having a sectional circle equivalent diameter in the range of 1 to 50 nm and an aspect ratio of 15 or more.

(12) A third aspect of the invention is an alkaline earth metal crystal having a sectional circle equivalent diameter in the range of 2 to 20 nm and an aspect ratio of 20 or more.

(13) A fourth aspect of the invention is alkaline earth metal carbonate crystal produced according to any one of the (1) through (10).

According to the method of the invention, an alkaline earth metal carbonate crystal having an aspect ratio of 1.5 or more can be generated. Furthermore, according to the method of the invention, a needle or bar alkaline earth metal carbonate crystal having a sectional circle equivalent diameter of 50 nm or less and an aspect ratio of 15 or more can be generated. When the alkaline earth metal carbonate crystal obtained by the method according to the invention is used in an optical resin, an optical product very low in the birefringence can be obtained, and an optical product that maintains the optical characteristics (for instance, heat-resistance and transparency) that the optical resin intrinsically has can be obtained.

### BRIEF DESCRIPTION OF THE DRAWINGS

FIG. 1 is a TEM graph of a strontium carbonate crystal prepared according to example 1 of the present invention.

FIG. 2 is a TEM graph of a strontium carbonate crystal prepared according to example 2 of the present invention.

### BEST MODE FOR CARRYING OUT THE INVENTION

In what follows, a method for producing an alkaline earth metal carbonate crystal according to the invention and the alkaline earth metal carbonated crystal will be detailed. In the specification, a numerical range expressed with “−” means a range that includes numerical values described before and after the “−” as the lower and upper limit values.

A method according to the invention includes reacting an alkaline earth metal ion and a carbonate ion under an alkali condition to generate an alkaline earth metal carbonate crystal having an aspect ratio of 1.5 or more.

The alkaline earth metal ion that is used in the invention, without restricting to particular one, may be any one of metal ions belonging to the II group of the periodic table. More specifically, at least one kind selected from the group consisting of Be²⁺, Mg²⁺, Ca²⁺, Sr²⁺, Ba²⁺ and Ra²⁺ can be exemplified, and more preferably Ca²⁺, Sr²⁺ and Ba²⁺ can be selected.

The foregoing alkaline earth metal ion can be normally supplied as an alkaline earth metal compound containing an anion. Examples of the alkaline earth metal compound include compounds made of an alkaline earth metal ion and a hydroxide ion, a halide ion, a nitrate ion, a sulfate ion, an acetate ion or the like. That is, hydroxides of alkaline earth metals, halides of alkaline earth metals, nitrates of alkaline earth metals, sulfates of alkaline earth metals, acetates of alkaline earth metals and so on can be cited. Since the hydroxides or acetates of alkaline earth metals can obtain a dissolution speed suitable for a reaction and a generated by-product can be easily purified, these can be preferably used as a supply source of the alkaline earth metal ion.

An ion concentration of the alkaline earth metal ion, as far as it is 0.5 mol/L or less, is not particularly restricted. It is preferably in the range of 5×10⁻⁵-2×10⁻¹ mol/L, and more preferably in the range of 1×10⁻⁴-1×10⁻¹ mol/L. When the ion concentration of the alkaline earth metal ion is 0.5 mol/L or less, a needle or bar alkaline earth metal carbonate crystal can be grown.

When the alkaline earth metal compound is supplied, in order to grow obtained carbonate crystal into a needle or bar shape, the alkaline earth metal compound is desirably supplied by taking into consideration the solubility thereof to a solvent. For instance, when an alkaline earth metal compound (for instance, Sr(OH)₂) that is low in the solubility to a solvent is used, an amount of the alkaline earth metal compound that is used is beforehand added in a solvent to be supplied. At that time, the alkaline earth metal compound is present at a saturation concentration thereof in the solvent and an un-dissolved portion is present as solid in a reaction system. On the other hand, when an alkaline earth metal compound (for instance, Sr(CH₃COO)₂) that is relatively high in the solubility to a solvent is used, in order to inhibit from forming aggregated crystals, the alkaline earth metal compound is preferably gradually added to a reaction solvent or a thick solution prepared beforehand is preferably dropped in a reaction solution.

A carbonate-ion supplying material that is used in the method of the invention is not particularly restricted and, for instance, various kinds of carbonates such as ammonium carbonate ((NH₄)₂CO₃), ammonium hydrogen carbonate (NH₄HCO₃), sodium carbonate (Na₂CO₃), sodium hydrogen carbonate (NaHCO₃), potassium carbonate (K₂CO₃) and potassium hydrogen carbonate (KHCO₃) and carbondioxide gas (CO₂) can be used. Carbondioxide gas may be directly introduced in a reaction solution for use or may be previously absorbed in a basic solution such as amino alcohol and so on for use. Among these, at least one kind selected from the group consisting of ammonium carbonate, ammonium hydrogen carbonate and carbon dioxide gas, because a generated byproduct thereof can be volatilized and these can be readily purified, can be preferably used.

An ion concentration of the carbonate ion in a reaction system, without particularly restricting, may be a concentration equivalent to or more than the ion concentration of the alkaline earth metal ion that is used (for instance, a case where a carbonate ion is present in excess in a solvent) or may be a concentration less than that.

A reaction between the alkaline earth metal and the carbonate ion in the method according to the invention is carried out under an alkali condition. In the present specification, the “alkali condition” means that the pH value of a solution that contains an alkaline earth metal and a carbonate ion is 10 or more. The pH value is preferably in the range of 11-13.8 and more preferably in the range of 12-13.8.

In the invention, a reaction between the alkaline earth metal ion and the carbonate ion can be carried out in the presence of, other than an inorganic base such as lithium hydroxide, sodium hydroxide or potassium hydroxide, an organic base such as aminoalcohols, guanidines or amidines. When such a base is used, needle or bar crystal can be obtained. In particular, aminoalcohols (for instance, 2-aminoethanol, dimethylaminoethanol, diethylaminoethanol, diethanolamine, triethanolamine and so on) that readily volatilize and allow readily purifying an alkaline earth metal carbonate crystal can be preferably used.

A reaction between the alkaline earth metal ion and the carbonate ion in the method according to the invention is carried out in a proper solvent. A solvent that is used in the method according to the invention, as far as it can dissolve an alkaline earth metal compound and a carbonate compound and allows an alkaline earth metal ion and a carbonate ion to react in a reaction, is not particularly restricted. For instance, water, alcohols, the foregoing amino alcohols, or mixed solvents of water and the foregoing organic solvents can be used as solvents in the invention. In particular, water or a mixed solvent of water and an aminoalcohol can be preferably used.

A reaction between the alkaline earth metal ion and the carbonate ion in the method according to the invention is carried out in the foregoing solvent. However, from a viewpoint of improving the dispersibility of the generated alkaline earth metal carbonate crystal, a dispersing agent can be preferably used. As a dispersing agent that can be used with such an intention, for instance, anionic surfactants, nonionic surfactants, polyvinyl alcohol, polyethylene glycol, carrageenan, gelatin and so on can be cited. Among these, gelatin can be preferably used.

When the alkaline earth metal ion and the carbonate ion are reacted, an order in blending an alkaline earth metal ion and a carbonate ion is not particularly restricted. For instance, in a solution that contains an alkaline earth metal ion a solution that contains a carbonate ion may be blended to react, or in a solution that contains a carbonate ion a solution that contains an alkaline earth metal ion may be added. Furthermore, both solutions may be simultaneously blended. Still furthermore, mixing speeds when both ions are blended, in order to obtain a needle or bar alkaline earth metal carbonate crystal having an aspect ratio of 1.5 or more, can be properly determined so that ion concentrations may be 0.5 mol/L or less. However, when an addition speed is too low, a reaction takes a longer time. Accordingly, the ion concentration and mixing speed in each of the solutions are desirably controlled so as to be substantially 10⁻²-10³ mL/min and preferably so as to be 10⁻¹-10² mL/min.

In the method according to the invention, the alkaline earth metal ion and the carbonate ion react and can generate an alkaline earth metal carbonate crystal having an aspect ratio of 1.5 or more. In the specification, the “aspect ratio” means a ratio of an average value of a length in a growth direction of crystal to an average value of a sectional circle equivalent diameter orthogonal to a growth direction of the alkaline earth metal carbonate crystal. When the aspect ratio is large, a growth direction coincides with a longer direction of the crystal. Furthermore, the “sectional circle equivalent diameter” means a diameter of a circle having an area same as a cross sectional area of the alkaline earth carbonate crystal. The aspect ratio of the alkaline earth metal carbonate crystal generated according to the method of the invention is 1.5 or more, preferably 5 or more, and more preferably 10 or more.

In the method according to the invention, the generated alkaline earth metal carbonate crystal is isolated, purified and dried and thereby a targeted alkaline earth metal carbonate crystal can be obtained. When gelatin is used in a reaction of an alkaline earth metal ion and a carbonate ion, gelatin in an aqueous solution of gelatin is preferably decomposed, followed by drying the generated alkaline earth metal carbonate crystal. Before and after the decomposition of the gelatin, centrifugation or decantation may be applied to purify. When the gelatin is present in the drying, the gelatin works as a binder between alkaline earth metal carbonate crystals to form an aggregated crystal. When the gelatin is decomposed, the alkaline earth metal carbonate crystals can be inhibited from forming the aggregated crystals. In order to decompose the gelatin, in the method according to the invention, for instance, a gelatin-decomposing enzyme (actiase) or the like can be used.

When the generated alkaline earth metal carbonate crystal is dried, various kinds of drying methods can be used. Among these, from a viewpoint of inhibiting to form aggregated crystals, the freeze drying or spray drying can be preferably used to dry the alkaline earth metal carbonate crystal. Furthermore, after the drying, sintering can be followed. A sintering temperature can be arbitrarily set at a temperature of 100 degrees centigrade or more and a decomposition temperature of the crystal or less.

A surface of the alkaline earth metal carbonate crystal, from a viewpoint of suppressing the crystal from growing during the purification or in the optical resin, is preferable to be beforehand covered with a compound insoluble in water. A water-insoluble compound that is used to cover a crystal surface is not particularly restricted. For instance, a silane coupling agent, a titanium coupling agent or a polymer compatible with the optical resin can be cited. Among these, the silane coupling agent or the titanium coupling agent can be preferably used.

The silane coupling agents that can be used in the method according to the invention include tetraethoxysilane, vinyltriethoxysilane, 3-glycidoxypropyltrimethoxysilane, and 3-aminopropyltrimethoxysilane, and the titanium coupling agents include titanium isopropoxide and a compound commercially available by a trade name of Plenact (produced by Ajinomoto Fine Techno Co., Ltd.).

The method according to the invention may further include, as need arise, other than the foregoing processes, processes that are used in a general method for producing carbonate crystal (for instance, agitating, isolating, purifying and so on). As the conditions in the other processes, conditions in general processes for production can be used.

In the next place, an alkaline earth metal carbonate crystal according to the invention will be described.

In the alkaline earth metal carbonate crystal according to the invention, a sectional circle equivalent diameter is in the range of 1-50 nm and an aspect ratio is 15 or more. Among existing alkaline earth metal carbonate crystals, ones that have the slenderness of substantially 20 nm in the sectional circle equivalent diameter are at most substantially 200 nm in the length in a crystal growth direction and substantially 10 in the aspect ratio. On the other hand, a sectional circle equivalent diameter of an alkaline earth metal carbonate crystal according to the invention is 50 nm or less and the aspect ratio thereof is 15 or more (length in the crystal growth direction: 750 nm or more).

The sectional circle equivalent diameter of an alkaline earth metal carbonate crystal according to the invention, when it is 50 nm or less, is not particularly restricted. It is preferably in the range of 2-20 nm, and more preferably in the range of 5-20 nm. The aspect ratio of the alkaline earth metal carbonate crystal according to the invention, as far as it is 15 or more, is not particularly restricted. It is preferably 20 or more and more preferably 50 or more. Even when the carbonate crystal has a high aspect ratio of 50 or more, there is no particular problem because at the blending with an optical resin it is cut to a length of sub-micrometer.

The alkaline earth metal carbonate of the invention can be produced according to the method of the invention described above.

The alkaline earth metal carbonate crystal according to the invention, being the needle or bar crystal high in the aspect ratio, when blended with an optical resin, can sufficiently reduce the birefringence. As optical resins that can be blended, various kinds of resins that can be formed in film according to a stretching method or an injection molding method (resins described in WO 03/076982 A1, WO 01/25364 A1) can be used.

In what follows, features of the invention will be more specifically described with reference to examples. Materials, amounts that are used, ratios, contents of process, procedures and so on shown in examples below can be properly altered as far as these do not deviate from a scope of the present invention. Accordingly, ranges according to the invention should not be construed limited by specific examples shown below.

### EXAMPLE 1

### Synthesis of Strontium Carbonate Crystal

Two grams of 860 gelatin (produced by Nitta Gelatin Inc.) was dissolved in 60 ml of water at 40 degrees centigrade, followed by suspending 10 g of strontium hydroxide octahydrate therein to prepare a I solution. Furthermore, 3.2 g of ammonium hydrogen carbonate was dissolved in 20 ml of water, followed by adding and blending 18 ml of 2-aminoethanol to prepare a II solution.

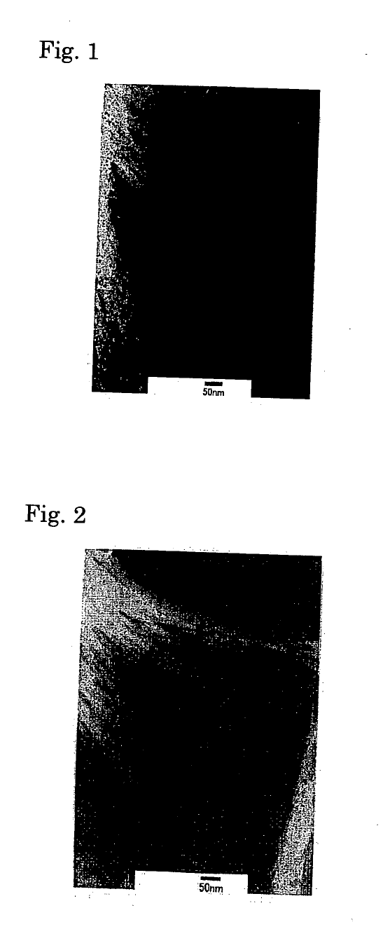

With the I solution agitating at 40 degrees centigrade, therein the II solution was added at a speed of 2 ml/min, followed by further agitating for 30 min after the completion of adding, and thereby a white dispersion of strontium carbonate crystal was obtained. A TEM graph of the obtained strontium carbonate crystal is shown in FIG. 1. This was confirmed to be strontium carbonate by XRD.

As shown in FIG. 1, a cross sectional circle equivalent diameter of the strontium carbonate crystal was 10 nm, and a length thereof was 1 μm or more. From this, it is understood that according to the method of the invention a needle crystal of strontium carbonate (the aspect ratio: 100 or more) was obtained.

### EXAMPLE 2

### Surface Treatment, Drying and Sintering of Strontium Carbonate Crystal

To the white dispersion of strontium carbonate, 100 mg of a gelatin decomposing enzyme (actiase) was added, followed by agitating at 35 degrees centigrade for 2 hr. When it was stood still, crystals of strontium carbonate precipitated. A supernatant liquid was removed, 200 mL of water was added followed by centrifuging at 3000 rpm for 5 min, further followed by washing crystallites of strontium carbonate. After the washing, a supernatant liquid was removed, 100 mL of a 1% isopropanol solution of a titanium coupling agent (trade name, KR-138S, produced by Ajinomoto Fine Techno Co., Ltd.) was added, followed by centrifuging at 3000 rpm for 5 min. To the obtained precipitate, 200 mL of water was added, followed by centrifuging at 3000 rpm for 5 min, further followed by freeze drying the precipitate, still further followed by sintering at 500 degrees centigrade for 1 hr, and thereby a strontium carbonate crystal was obtained. A TEM graph of the obtained strontium carbonate crystal is shown in FIG. 2.

As shown in FIG. 2, a sectional circle equivalent diameter of the obtained strontium carbonate crystal was substantially 10 nm and a length thereof was 1 μm or more. From this, it is understood that, when the crystal is surface treated, dried and sintered, a more stable needle strontium carbonate crystal (the aspect ratio: 100 or more) can be obtained.

### EXAMPLE 3

### Preparation of Optical Film Specimen and Measurement of the Birefringence

By use of a MiniLab type kneader (produced by Haake Inc.), 7 g of polycarbonate (trade name: MD1500, produced by Idemitsu Kosan Co., Ltd.) was melted at 250 degrees centigrade. After melting for 5 min, 70 mg of the strontium carbonate crystal according to example 2 and 7 mg of stearic acid (special grade chemical produced by Wako Pure Chemical Industries Ltd.) were added, followed by kneading at a number of revolutions of the kneader of 50 rpm for 30 min at 250 degrees centigrade. After the kneading, a sample was molded in tablet at 250 degrees centigrade by use of an injection molding device produced by Haake Inc. A tablet-shaped sample was pressed at a temperature of 200 degrees centigrade and a pressure of 30 MPa for 3 min by use of a heating press (trade name: miniTESTPRESS-10, produced by Toyo Seiki Seisaku-sho, Ltd.), and thereby an optical film sample having a thickness of 120 μm was prepared.

The obtained strontium carbonate crystal-containing polycarbonate film was subjected to heating and stretching at 200 degrees centigrade by use of a tensile testing machine (RTC-1210A produced by ORIENTEC CO., LTD.). A ratio of a length of a stretched film to a length of a film before stretching is defined as a stretching multiplying power. Film samples of the stretching multiplying powers of 1.0 (non-stretched) and 1.5 were prepared, followed by measuring the birefringence under a circumstance of 25 degrees centigrade and 60% RH by use of an automatic birefringence measuring device (trade name: ABR-10A, produced by Uniopt Inc.). Results are shown in Table 1.

### COMPARATIVE EXAMPLE 1

Except that the strontium carbonate crystal was not used, similarly to a method according to example 3, polycarbonate films were prepared, followed by measuring the birefringence. Results are shown in Table 1.

TABLE 1

Birefringence

| | Multiplying | Multiplying |
|---|---|---|
| | power 1 | power 1.5 |
| Comparative example | 0.5 × 10⁻⁴ | 18 × 10⁻⁴ |
| (without SrCO₃) | | |
| Example 3 (with SrCO₃ added by | −0.2 × 10⁻⁴ | 0.3 × 10⁻⁴ |
| 1% by mass) | | |

From Table 1, the strontium carbonate crystal-containing film according to the invention, even after the stretching, could maintain low birefringence. Contrary to this, in the film according to comparative example 1, after the stretching, the birefringence became much larger. Accordingly, it is found that the optical film containing alkaline earth metal carbonate crystal according to the invention can control the generation of the birefringence due to the stretching.

### COMPARATIVE EXAMPLE 2

### Synthesis of Strontium Carbonate Crystal Under High Strontium Ion Concentration

In example 1, when, in place of strontium hydroxide octahydrate, an equivalent mol (10 g) of strontium chloride hexahydrate was added, a completely dissolved solution I was obtained. A concentration of Sr²⁺ ion in the reaction liquid was substantially 0.6 mol/L. Except that the solution I was used, similarly to example 1, a strontium carbonate crystal was obtained. A sectional circle equivalent diameter was substantially 25 nm and a length was substantially 30 nm (aspect ratio: substantially 1.2). Similarly to example 3, an optical film sample was prepared (added by 1% by mass), measured of the birefringence and found to be substantially identical as a sample in which the carbonate crystal was not added.

### EXAMPLE 4

### Synthesis of Barium Carbonate Crystal

In example 1, except that in place of strontium hydroxide, 12 g of barium hydroxide octahydrate was suspended to prepare a I solution, similarly to example 1, a barium carbonate crystal was obtained. Similarly to example 2, surface treatment, drying and sintering were carried out. A sectional circle equivalent diameter of the obtained crystal was substantially 20 nm and a length thereof was 1 μm (aspect ratio: 50 or more).

When alkaline earth metal carbonate crystal according to the present invention is used, the birefringence of an optical resin can be suppressed low. Accordingly, the invention can be widely used in optical films that can be used in image display devices such as flat panel displays such as liquid crystal, plasma display, electroluminescence (EL), fluorescent display tube, and light-emitting diode; solar batteries; and touch panels.

The present disclosure relates to the subject matter contained in Japanese Patent Application No. 123657/2004 filed on Apr. 20, 2004, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A method for producing an alkaline earth metal carbonate crystal, comprising:
allowing an alkaline earth metal ion that is present at an ion concentration of 0.5 mol/L or less and a carbonate ion to react under an alkali condition to generate an alkaline earth metal carbonate crystal having an aspect ratio of 1.5 or more.

2. The method according to claim 1, wherein the alkaline earth metal ion is Ca²⁺, Sr²⁺ or Ba²⁺.

3. The method according to claim 1, wherein the ion concentration of the alkaline earth metal ion is in the range of 5×10⁻⁵-2×10⁻¹ mol/L.

4. The method according to claim 1, wherein, as a material that supplies the alkaline earth metal ion, an alkaline earth metal hydroxide, an alkaline earth metal halide, an alkaline earth metal nitrate, an alkaline earth metal sulfate or an alkaline earth metal acetate is used.

5. The method according to claim 1, wherein, as a material that supplies the alkaline earth metal ion, an alkaline earth metal hydroxide or an alkaline earth metal acetate is used.

6. The method according to claim 1, wherein, as a material that supplies the carbonate ion, at least one kind selected from the group consisting of ammonium carbonate, ammonium hydrogen carbonate, sodium carbonate, sodium hydrogen carbonate, potassium carbonate, potassium hydrogen carbonate and carbon dioxide gas is used.

7. The method according to claim 1, wherein, as a material that supplies the carbonate ion, at least one kind selected from the group consisting of ammonium carbonate, ammonium hydrogen carbonate and carbon dioxide gas is used.

8. The method according to claim 1, wherein the reaction is carried out at a pH in the range of 10-13.8.

9. The method according to claim 1, wherein the reaction is carried out in the presence of an aminoalcohol, a guanidine or an amidine.

10. The method according to claim 1, wherein the reaction is carried out in the presence of an aminoalcohol.

11. The method according to claim 1, wherein the reaction is carried out in the presence of gelatin.

12. The method according to claim 11, further comprising:
decomposing the gelatin.

13. The method according to claim 1, further comprising:
drying the generated alkaline earth metal carbonate crystal.

14. The method according to claim 13, wherein the generated alkaline earth metal carbonate crystal is dried by means of freeze drying or spray drying.

15. The method according to claim 1, further comprising:
sintering the generated alkaline earth metal carbonate crystal.

16. The method according to claim 1, further comprising:
covering a surface of the generated alkaline earth metal carbonate crystal with a compound insoluble in water.

17. The method according to claim 16, wherein, as the compound insoluble in water, a silane coupling agent or a titanium coupling agent is used.

18. An alkaline earth metal crystal having a sectional circle equivalent diameter in the range of 1-50 nm and an aspect ratio of 15 or more.

19. An alkaline earth metal crystal having a sectional circle equivalent diameter in the range of 2-20 nm and an aspect ratio of 20 or more.

20. An alkaline earth metal carbonate crystal produced by the method according to claim 1.
